(19) United States
(12) Patent Application Publication
(10) Pub. No.: US 2024/0355144 A1
(43) Pub. Date: Oct. 24, 2024

(54) METHOD AND APPARATUS FOR CAPTURING CHANGE IN HUMAN POSTURE AND MONITORING IMAGE USING LEARNING MODEL

(71) Applicant: Hanwha Vision Co., Ltd., Seongnam-si (KR)

(72) Inventors: Chan Young SOHN, Seongnam-si (KR); Hyun Hak SHIN, Seongnam-si (KR); Jeong Eun LIM, Seongnam-si (KR); Seung In NOH, Seongnam-si (KR)

(73) Assignee: Hanwha Vision Co., Ltd., Seongnam-si (KR)

(21) Appl. No.: 18/640,835

(22) Filed: Apr. 19, 2024

(30) Foreign Application Priority Data
Apr. 19, 2023 (KR) 10-2023-0051570
Aug. 24, 2023 (KR) 10-2023-0111505

(51) Int. Cl. G06V 40/20; G06V 10/25

(52) U.S. Cl. CPC G06V 40/23; G06V 10/25

(57) ABSTRACT

An image capturing device includes a memory configured to store instructions and a processor configured to execute the instructions to perform detecting a person having an identifier from consecutive frames using a first learning model, determining a candidate target based on the person having the identifier and a candidate algorithm, determining a region of interest (ROI) including the candidate target, estimating a pose of the person having the identifier in the ROI using a second learning model, and determining, based on the poses of the person, whether the person having the identifier has fallen.

### CROSS-REFERENCE TO RELATED APPLICATION

This application is based on and claims priority to Korean Patent Application Nos. 10-2023-0051570, filed on Apr. 19, 2023, and 10-2023-0111505, filed on Aug. 24, 2023, in the Korean Intellectual Property Office, the disclosures of which are incorporated by reference herein in their entireties.

### BACKGROUND

### 1. Field

The disclosure relates to a technology for capturing a change in human posture using a learning model, and more particularly, to a technology for detecting a human fall using a learning model.

### 2. Description of the Related Art

With a rapid growth of urban areas and an increasing need for public safety and security, use of image capturing devices, such as closed-circuit televisions (CCTVs), has become widespread in various locations, such as streets, buildings, and public places. Such image capturing devices capture images and transmit image data to a server so that users may review and analyze the images captured by the image capturing devices.

Technologies for classifying human poses from image data have been developed, but it is difficult to effectively apply these technologies to real-time images due to limitations in resources, operation processing speeds, or the like.

### SUMMARY

Provided is an image display system for detecting a human fall using a learning model.

Various aspects of the disclosure will be set forth in part in the description which follows and, in part, will be apparent from the description, or may be learned by practice of the presented embodiments.

According to an aspect of the disclosure, an image capturing device may include a memory configured to store instructions and a processor configured to execute the instructions to perform: detecting a person having an identifier from consecutive frames using a first learning model, determining a candidate target based on the person having the identifier and a candidate algorithm, determining a region of interest (ROI) including the candidate target, estimating a pose of the person having the identifier in the ROI using a second learning model, and determining, based on the poses of the person, whether the person having the identifier has fallen.

The detecting of the person having the identifier may include inputting the consecutive frames to the first learning model, using the person as an object in the consecutive frames and obtaining a first bounding box corresponding to a head of the person and a second bounding box corresponding to an entire body of the person, and determining, as the identifier, persons associated with each other between objects based on the consecutive frames, the first bounding box, and the second bounding box.

The determining of the candidate target may include determining the candidate target based on whether the person having the identifier is occluded by another object.

The determining of the candidate target may further include determining that the person is occluded when an amount of decrease in a height of the second bounding box in a second frame compared to a first frame is greater than or equal to a first threshold and when an amount of increase in coordinates of a lower end of the second bounding box in the second frame compared to the first frame is greater than or equal to a second threshold, wherein the first frame and the second frame exist in the consecutive frames, and the first frame is before the second frame.

The determining of the candidate target may include determining the candidate target based on an aspect ratio of the second bounding box when the person having the identifier is detected in a first frame and a second frame, wherein the first frame and the second frame exist in the consecutive frames, and the first frame is before the second frame.

The determining of the candidate target may further include determining the person having the identifier as the candidate target when the person having the identifier is detected in the first frame and the second frame and an amount of decrease in a height of the second bounding box in the second frame compared to the first frame is greater than or equal to a threshold.

The determining of the candidate target may further include determining the person having the identifier as the candidate target when the person having the identifier is detected in the first frame and the second frame and an amount of change in a position of the first bounding box in the second frame compared to the first frame is greater than or equal to a threshold.

The determining of the candidate target may include, when the person having the identifier is detected in a first frame and a third frame but not detected in a second frame, determining the candidate target based on an amount of change in an aspect ratio of the second bounding box and an amount of change in a height of the second bounding box in the third frame compared to the first frame, wherein the first frame, the second frame, and the third frame exist in the consecutive frames, the first frame is before the second frame, and the third frame is between the first frame and the second frame.

The determining of the ROI may include determining the ROI including a motion detection box and a bounding box of the candidate target.

The first learning model may include an object recognition model, and the second learning model may include a model for classifying poses of the person.

The second learning model may classify the poses of the person into a standing pose, a bending pose, a sitting pose, and a lying pose.

The determining of whether the person having the identifier has fallen may include determining that the person having the identifier has fallen when the person corresponds to the candidate target and the pose of the person corresponds to the lying pose.

The second learning model may be created by generating a data set in which a plurality of images relating to poses of the person are respectively labelled with a standing pose, a bending pose, a sitting pose, and a lying pose.

According to another aspect of the disclosure, provided is a computer-readable recording medium on which a computer program is recorded, wherein the computer program instructions that cause a processor to perform detecting a person having an identifier from consecutive frames using a first learning model, determining a candidate target based on the person having the identifier and a candidate algorithm, determining an ROI including the candidate target, estimating a pose of the person having the identifier in the ROI using a second learning model, and determining, based on the poses of the person, whether the person having the identifier has fallen.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 shows an image monitoring system according to one or more embodiments;

FIG. 2 is a flowchart illustrating an operation of detecting a fall on a computer device according to one or more embodiments;

FIG. 3 is a diagram showing a bounding box according to one or more embodiments;

FIG. 4 is a diagram showing a region of interest according to one or more embodiments;

FIG. 5 is a flowchart illustrating an operation of determining a candidate on the computer device according to one or more embodiments;

FIG. 6 is a diagram showing a learning model according to one or more embodiments;

FIG. 7 is a flowchart illustrating an operation of creating the learning model on the computer device according to one or more embodiments; and

FIG. 8 is a block diagram showing a block configuration of the computer device according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Terms used in the disclosure are only used to describe specific embodiments and may not be intended to limit the scope of other embodiments. The singular forms may include the plural forms as well, unless the context clearly indicates otherwise. Terms used herein, including technical or scientific terms, may have the same meanings as those generally understood by those skilled in the art to which the disclosure pertains. Among the terms used herein, the terms as defined in a commonly used dictionary should be construed as having the same or similar meaning as in an associated technical context, and unless defined apparently in the description, these terms should not be interpreted abnormally or as having an excessively formal meaning. In some cases, even terms defined in the disclosure cannot be interpreted to exclude embodiments.

Hereinafter, various embodiments are described in detail with reference to the accompanying drawings so that those skilled in the art can easily practice the disclosure. However, the technical idea of the disclosure can be modified and embodied in various forms and not limited to the embodiments described herein. In describing the embodiments disclosed herein, if it is determined that detailed descriptions related to well-known technologies obscure subject matters of the inventive concept, the detailed descriptions of the well-known technologies may be omitted. The same reference numerals are given to the identical or similar components, and repeated descriptions thereof are omitted.

Also, the term ‘-unit’ used in the embodiment represents a component that performs a specific function with software, hardware or a combination thereof, such as a field programmable gate array (FPGA) and an application specific integrated circuit (ASIC). However, the term ‘-unit’ is not limited to being performed by the software, the hardware or the combination thereof. The term ‘-unit’ may exist in the form of data stored in an addressable storage medium and may be operated by commands so that one or more processors are configured to perform specific functions.

The software may include computer programs, codes, instructions, or a combination thereof and may configure processing devices to operate in a desired manner or instruct the processing devices independently or collectively. The software and/or data may be embodied permanently or temporarily in any type of machines, components, physical devices, virtual equipment, computer storage media or devices, or transmitted signal waves, so that software and/or data is interpreted by a processing device or provides instructions or data to the processing device. The software may be distributed over computer systems connected via a network and then stored or executed in a distributed manner. The software and data may be stored on one or more computer-readable recording media. The software may be read into a main memory from another computer-readable medium, such as a data storage device, or from another device via a communication interface. Software commands stored in the main memory may cause a processor to perform processes or operations, which are described below in detail. Alternatively, processes consistent with the principles of the disclosure may be performed using hardwired circuitry instead of or in combination with the software commands. Therefore, embodiments consistent with the principles of the disclosure are not limited to any particular combination of hardware circuits and software.

In the disclosure, it will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof. Although the terms “first,” “second,” or the like may be used herein to describe various elements, these elements should not be limited by these terms. These terms are used only for the purpose of distinguishing one component from another.

A ‘learning model’ described in the disclosure may include any type of algorithm or methodology used to learn or understand a specific pattern or structure from data. This includes, but not limited to, traditional statistical models, machine learning models, deep learning models, reinforcement learning models, and other learning methodologies.

In other words, the learning model may include not only the machine learning models, such as regression models, decision trees, random forests, support vector machines, K-nearest neighbors, Naive Bayes, and clustering algorithms but also the deep learning models, such as neural networks, convolutional neural networks, recurrent neural networks, transformer-based neural networks, generative adversarial networks (GANs), and autoencoders. The ‘learning model’ may specify learned parameters or weight groups that are used to predict or classify the output for a specific input. This model may be learned through methods, such as supervised learning, unsupervised learning, semi-supervised learning, and reinforcement learning. Also, this may include not only a single model but also various learning methods and structures, such as ensemble models, multi-modal models, and models through transfer learning. This learning model may be pre-trained in a computer device separate from the computer device that predicts the output for the input and may be used in another computer device.

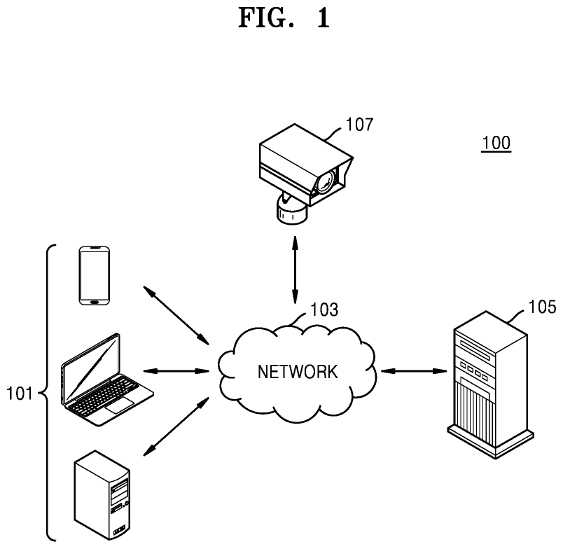

FIG. 1 shows an image monitoring system 100 according to one or more embodiments. The image monitoring system 100 is a system in which an image is transmitted from a server 105 to a user terminal 101 via a network 103, and the user terminal 101 displays the image on a display. The image in the image monitoring system 100 may be an image that is transmitted from an image capturing device to a server. The image monitoring system 100 according to the embodiments may be configured to detect a person falling.

Referring to FIG. 1, the image monitoring system 100 may include the network 103, the server 105, the user terminal 101, and an image capturing device 107. FIG. 1 shows an example of the disclosure, and the number of devices connected to the network 103 in this system according to one or more embodiments is not limited thereto.

The network 103 may be a network for wired or wireless communication among a plurality of devices. According to one or more embodiments, the network 103 may include wired networks, such as local area networks (LANs), wide area networks (WANs), metropolitan area networks (MANs), and integrated service digital networks (ISDNs), and wireless networks, such as wireless LANs, code division multiple access (CDMAs), Bluetooth, and satellite communication. The network 103 may include a closed network with no contact points or nodes connected to an external network. In other words, the network 103 may include communication lines that connect only predetermined components to each other. According to one or more embodiments, the network 103 may include communication lines that connect the server 105, the user terminal 101, and the image capturing device 107 to each other.

The server 105 may be provided as a computer device or a plurality of computer devices that communicate with the user terminal 101 over a network 103 so as to provide instructions, codes, files, contents, services, or the like. According to one or more embodiments, the server 105 may create a user interface. In addition, the server 105 may provide contents to the user terminal 101. The user terminal 101 may be connected to the server 105 under control by at least one program and may receive services or contents provided by the server 105.

The user terminal 101 refers to an electronic device that acquires information over the network 103 and provides the obtained information to a user. The user terminal 101 includes a fixed user terminal or a mobile user terminal, which is provided as a computer device. According to one or more embodiments, the user terminal 101 may include smart phones, mobile phones, navigation units, computers, laptops, digital broadcasting user terminals, personal digital assistants (PDAs), portable multimedia players (PMPs), and tablet personal computers (PCs). The user terminal 101 may communicate with the server 105 over the network 103 using a wireless or wired communication method. The user terminal 101 may receive a program or command from the server 105 and perform an operation according to the command.

According to one or more embodiments, the user terminal 101 may receive user inputs, such as touching, tapping, dragging, and clicking, from the user.

The image capturing device 107 refers to a device that captures and obtains images of a preset region for the purpose of surveillance, security, or the like. The image capturing device 107 may transmit the captured image to the server 105 or the user terminal 101. The shape and type of the image capturing device 107 shown in FIG. 1 are only examples and the disclosure is not limited thereto. Accordingly, when a device acquires an image and transmits the acquired image over a connected network, this device may correspond to the image capturing device 107.

The image monitoring system 100 according to one or more embodiments may display the captured image on a screen of the user terminal 101.

In the image monitoring system 100 according to one or more embodiments, the operation of determining whether a person has fallen using image monitoring is performed by at least one computer device among the image capturing device 107, the user terminal 101, and the server 105.

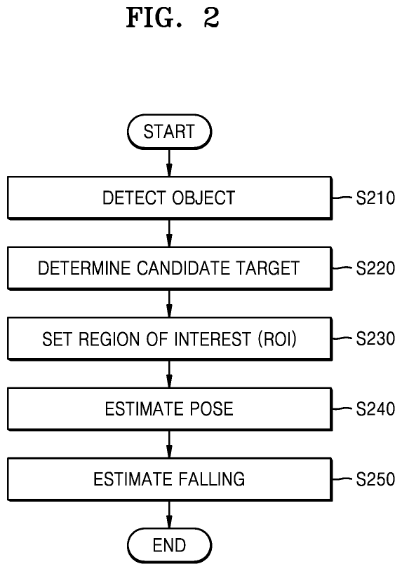

FIG. 2 is a flowchart illustrating an operation of detecting a fall in a computer device according to one or more embodiments.

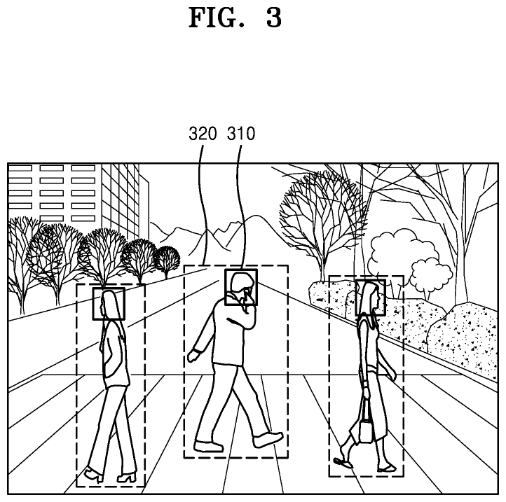

Referring to FIG. 2, in operation S210, the computer device according to one or more embodiments may detect a person having an identifier from consecutive frames in an image using a first learning model. The first learning model may include an object recognition model, for example, a model for detecting people. For example, the first learning model may be created by at least one of a region-based convolutional neural network (R-CNN), fast R-CNN, faster R-CNN, you only look once (YOLO), and a single shot multi-box detector (SSD). This first learning model may detect the entire body and face of a person and generate a first bounding box corresponding to the head of the person and a second bounding box corresponding to the entire body of the person. Referring to FIG. 3, the computer device may detect a person in one frame among consecutive frames and create a bounding box. The computer device may detect people regardless of their poses. Also, the computer device may create a first bounding box 310 corresponding to the head of a person and a second bounding box 320 corresponding to the entire body of the person, which may be used to determine a candidate.

For example, the first learning model may be a model created by simultaneously learning to detect the entire body and the face of a person through multi-task learning. Alternatively, the first learning model may include two independent models created through an integrated pipeline, one using an entire body detection model and the other using a face detection model. For example, the computer device may use algorithms, such as the YOLO and SSD, for detecting the entire body and may use algorithms, such as multi-task cascaded convolutional networks (MTCNNs), for detecting the face.

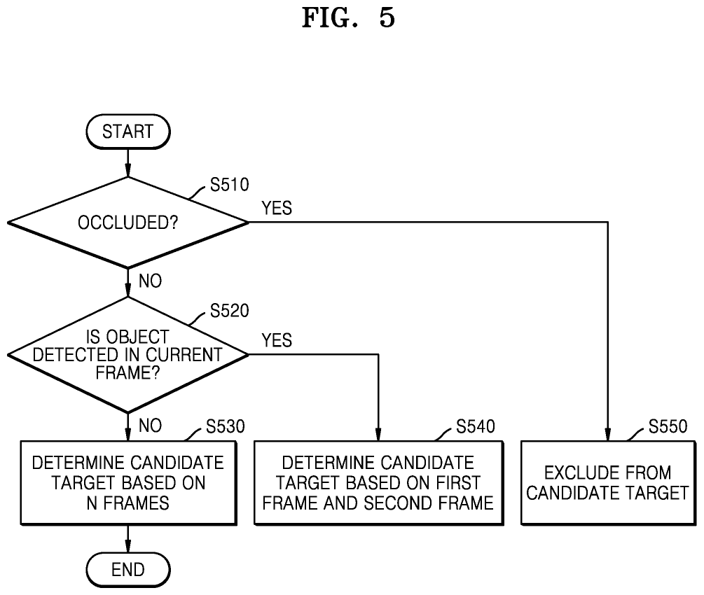

In operation S220, the computer device according to one or more embodiments may determine a candidate target on the basis of a person having an identifier and a candidate algorithm. For example, the computer device may determine the candidate target by checking whether the person having the identifier corresponds to the candidate according to the candidate algorithm. The candidate algorithm is described in detail in FIG. 5.

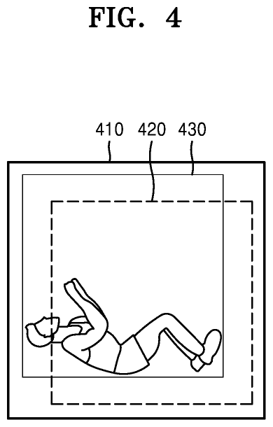

In operation S230, the computer device according to one or more embodiments may determine a region of interest (ROI) including a candidate target so as to check whether a person having an identifier is a candidate. For example, the computer device may determine, as the ROI, a region including a motion detection box and a bounding box of the candidate target. Referring to FIG. 4, when the person having an identifier is a candidate target, the computer device may perform motion detection on the candidate target. For example, the motion detection may refer to detecting the movement of a corresponding object by detecting a change in pixels on the basis of background subtraction or optical flow. The computer device may determine, as a motion detection box 430, the region in which the movement has been detected. The computer device may determine, as the ROI 410, the region including a bounding box 420 and the motion detection box 430 according to the object detection.

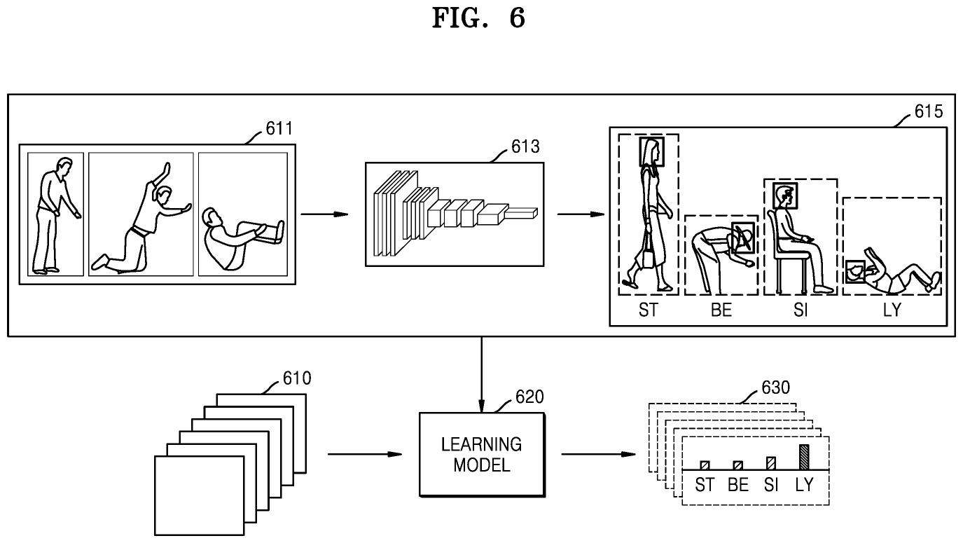

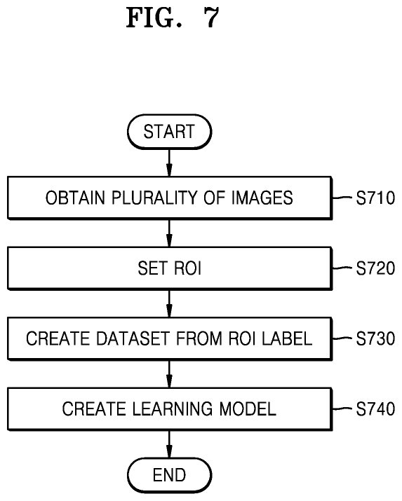

In operation S240, the computer device according to one or more embodiments may estimate the pose of the person having the identifier by using the ROI as an input to a second learning model. Also, the computer device may estimate the pose of the candidate target by using the ROI as an input to the second learning model. The second learning model may include a model that classifies poses of a person and may classify poses of the person into a standing pose, a bending pose, a sitting pose, and a lying pose. The second learning model is described in detail with reference to FIGS. 6 and 7.

In operation S240, the computer device according to one or more embodiments may determine whether the person having the identifier has fallen on the basis of the posture thereof. For example, the computer device may estimate that a person having an identifier has fallen, when the person having the identifier corresponds to a candidate and is in the lying pose.

FIG. 5 is a flowchart illustrating an operation of determining a candidate in a computer device according to one or more embodiments. The operation of the computer device in FIG. 5 may correspond to operation S220 in FIG. 2. The computer device may determine a candidate target on the basis of a person having an identifier and a candidate algorithm.

Referring to FIG. 5, in operation S510, the computer device may determine whether the person having the identifier is occluded by another object using comparison between consecutive frames. For example, the computer device may define a region of the bounding box, corresponding to the entire body of the person having the identifier, as a width and a height h and may determine whether the person has been occluded on the basis of a change Δh in height and a change Δy in y coordinate value at the bottom of the bounding box. For example, the computer device may determine that the person has been occluded, when the decrease in height of the bounding box in a second frame compared to a first frame is greater than or equal to a first threshold. This is because when a person is occluded by another object, the height of the bounding box decreases as the lower part of the person's body becomes invisible, resulting in a reduction in the area of the bounding box. Also, the computer device may determine that the person has been occluded, when the increase in coordinates of a lower end of the bounding box in the second frame compared to the first frame is greater than or equal to a second threshold. This is because when a person is occluded, the coordinates of the bottom of the bounding box increase as the lower part of the person's body is not visible. Here, the first frame and the second frame may exist in the consecutive frames, and the first frame may be before the second frame.

In the computer device according to one or more embodiments, when the person having the identifier is occluded by another object, the process proceeds to operation S550 and the person having the identifier may be excluded from the candidate target. This is to exclude a person from the fall estimation process if the person is occluded. The computer device may proceed to operation S520 when the person having the identifier is not occluded by another object.

In operation S520, the computer device according to one or more embodiments may check whether the person having the identifier continues to be detected in a current frame. The image has consecutive frames, and thus, even if a person having an identifier is detected in a past frame, the person having the identifier may not be detected in the current frame. That is, if a person having an identifier is detected in a first frame, which is the past frame, but the person having the identifier is not detected in a second frame, which is the current frame, the computer device proceeds to operation S530. On the other hand, if a person having an identifier is detected in both a first frame, which is the past frame, and a second frame, which is the current frame, the computer device may proceed to operation S540.

In operation S530, the computer device according to one or more embodiments may determine a candidate target on the basis of an amount of change in an aspect ratio and/or a height of the bounding box corresponding to the entire body of the person in a third frame compared to the first frame. Also, the first frame, the second frame, and the third frame may exist in the consecutive frames, the first frame may be before the second frame, and the third frame may be between the first frame and the second frame.

For example, when the bounding box for a person having an identifier is lost in the consecutive frames, the computer device may determine the person as a candidate for fall estimation. When discovering that the third frame, which is a frame in which the bounding box for the person having the identifier has disappeared, from the second frame, which is the current frame, the computer device may determine the candidate target by comparing frames between the first frame, in which the person having the identifier has been detected, and the third frame. When there are N frames between the first frame and the third frame, the computer device may determine the candidate target if the aspect ratio of the bounding box corresponding to the entire body of the person during the N frames decreases and the height thereof is reduced. Alternatively, the computer device may determine the candidate target by detecting a motion and checking a degree of overlap between frames of the person having the identifier.

In operation S540, the computer device according to one or more embodiments may determine the candidate target on the basis of at least one of the aspect ratio and the height of the bounding box corresponding to the entire body of the person and a relative position of the bounding box corresponding to the head of the person.

For example, when an amount of change in the aspect ratio of the bounding box corresponding to the entire body of a person in the second frame compared to the first frame is greater than or equal to a threshold, the computer device may determine the person as a candidate for fall estimation. As another example, when an amount of change in the height of the bounding box corresponding to the entire body of a person in the second frame compared to the first frame is greater than or equal to a threshold, the computer device may determine the person as a candidate for fall estimation. As still another example, when an amount of change in the relative position of the bounding box corresponding to the head of a person in the second frame compared to the first frame is greater than or equal to a threshold, the computer device may determine the person as a candidate for fall estimation.

FIG. 6 is a diagram showing a learning model according to one or more embodiments. The learning model in FIG. 6 may include a model for classifying poses of a person and may correspond to the second learning model in FIG. 2.

Referring to FIG. 6, the computer device may input images 610 for a plurality of ROIs according to consecutive frames into a learning model 620. The learning model 620 outputs classified posture results as shown by reference number 615, categorizing the images into standing (ST), bending (BE), sitting (SI), and lying (LY) poses. The computer device may determine whether the person is lying down on the basis of a plurality of output estimation results 630.

The learning model 620 may be created in such a manner of determining a candidate target; generating a data set by labeling the image data for the ROIs 611 with depicting a standing pose (ST), a bending pose (BE), a sitting pose (SI), and a lying pose (LY); and training a model 613 based on convolutional neural networks (CNNs).

FIG. 7 is a flowchart illustrating an operation of creating the learning model in the computer device according to one or more embodiments. The learning model in FIG. 7 may correspond to the second learning model in FIG. 2.

Referring to FIG. 7, in operation S710, the computer device may obtain a plurality of images. These images may include images acquired from various sources as well as images captured by an image capturing device.

In operation S720, the computer device according to one or more embodiments may determine an ROI. For example, the computer device may repeatedly perform operations S210 to S230 in FIG. 2 so as to obtain images corresponding to the plurality of ROIs from the plurality of images.

In operation S730, the computer device according to one or more embodiments may create a data set by labeling the images corresponding to the plurality of ROIs as a standing pose, a bending pose, a sitting pose, and a lying pose.

In operation S740, the computer device according to one or more embodiments may use the data set and create the learning model that classifies the poses of the person using the ROI as input.

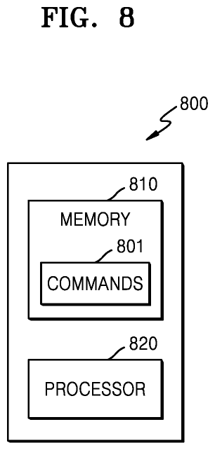

FIG. 8 is a block diagram showing a block configuration of the computer device according to one or more embodiments.

FIG. 8 schematically shows a configuration 800 of the computer device for at least one of the image capturing device 107, the user terminal 101, and the server 105 in the image monitoring system 100 according to various embodiments. The computer device may include a memory 810 and a processor 820. The computer device may execute one or more sets of commands 801 for performing any one or more of the methodologies described herein.

The memory 810 may store the set of commands 801, which includes commands associated with a system for performing any one or more of the methodologies and functions described herein and commands associated with a user interface. The memory 810 temporarily or permanently stores data, such as basic programs, application programs, and setting information, so as to operate devices. The memory 810 may include permanent mass storage devices, such as random access memory (RAM), read only memory (ROM), and disk drives, but the embodiment is not limited thereto. These software components may be loaded from computer-readable recording media separate from the memory 810 using a drive mechanism. This separate computer-readable recording media may include computer-readable recording media, such as floppy drives, disks, tapes, DVD/CD-ROM drives, and memory cards. According to one or more embodiments, the software components may be loaded into the memory 810 via a communication unit rather than the computer-readable recording media. Also, the memory 810 may provide the stored data in response to a request from the processor 820.

The processor 820 controls all operations of the device. In addition, the processor 820 may be configured to process instructions of a computer program by performing basic arithmetic, logic, and input/output operations. The instructions may be provided to the processor 820 by the memory 810. For example, the processor 820 may be configured to execute received instructions according to program codes stored in a recording device, such as the memory 810. For example, the processor 820 may control the device to perform operations according to various embodiments described below.

The processor 820 according to one or more embodiments may detect a person having an identifier from consecutive frames using a first learning model, determine a candidate target on the basis of the person having the identifier and a candidate algorithm, determine an ROI including the candidate target, estimate the pose of the person having the identifier using a second learning model in the ROI, and determine, based on the posture, whether the person having the identifier has fallen.

This processor 820 may be provided as a single central processing unit (CPU) or a plurality of CPUs (or a digital signal processor (DSP), a system on chip (SoC)). The processor 820 may be provided as a DSP, which processes digital signals, a microprocessor, or a time controller (TCON). However, the embodiment is not limited thereto. The processor 820 may include one or more of a CPU, a micro controller unit (MCU), a micro processing unit (MPU), a controller, an application processor (AP), and a communication processor (CP), and an ARM processor or may be defined as terms corresponding thereto.

The foregoing description of embodiments provides illustration and description, but is not intended to be exhaustive or to limit the disclosure to the precise forms disclosed herein. Modifications and variations are possible in light of the above teachings or may be acquired from practice of the disclosure. For example, while series of acts have been described with reference to FIGS. 2, 5, and 7, the order of the acts may be modified in other embodiments consistent with the principles of the disclosure. Further, non-dependent acts may be performed in parallel.

According to the embodiment, it is possible to more effectively detect whether the person has fallen.

The effects of the embodiment are not limited to the effects mentioned above, and other effects not described herein are clearly understood by those skilled in the art from the following description.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An image capturing device comprising a memory configured to store instructions and a processor configured to execute the instructions to perform:
detecting a person having an identifier from consecutive frames using a first learning model;
determining a candidate target based on the person having the identifier and a candidate algorithm;
determining a region of interest (ROI) comprising the candidate target; and
estimating a pose of the person having the identifier in the ROI using a second learning model.

2. The image capturing device of claim 1, wherein the detecting of the person having the identifier comprises:
inputting the consecutive frames to the first learning model;
using the person as an object in the consecutive frames and obtaining a first bounding box corresponding to a head of the person and a second bounding box corresponding to an entire body of the person; and
determining, as the identifier, persons associated with each other based on the consecutive frames, the first bounding box, and the second bounding box.

3. The image capturing device of claim 2, wherein the determining of the candidate target comprises determining the candidate target based on whether the person having the identifier is occluded by another object.

4. The image capturing device of claim 3, wherein the determining of the candidate target further comprises determining that the person is occluded based on:
an amount of decrease in a height of the second bounding box in a second frame compared to a first frame being greater than or equal to a first threshold; and
an amount of increase in coordinates of a lower end of the second bounding box in the second frame compared to the first frame being greater than or equal to a second threshold,
wherein the first frame and the second frame exist in the consecutive frames, and the first frame is before the second frame.

5. The image capturing device of claim 2, wherein the determining of the candidate target comprises determining the candidate target based on an aspect ratio of the second bounding box, based on the person having the identifier being detected in a first frame and a second frame,
wherein the first frame and the second frame exist in the consecutive frames, and the first frame is before the second frame.

6. The image capturing device of claim 5, wherein the determining of the candidate target further comprises determining the person having the identifier as the candidate target based on the person having the identifier being detected in the first frame and the second frame and an amount of decrease in a height of the second bounding box in the second frame compared to the first frame being greater than or equal to a threshold.

7. The image capturing device of claim 5, wherein the determining of the candidate target further comprises determining the person having the identifier as the candidate target based on the person having the identifier being detected in the first frame and the second frame and an amount of change in a position of the first bounding box in the second frame compared to the first frame being greater than or equal to a threshold.

8. The image capturing device of claim 2, wherein the determining of the candidate target comprises, based on the person having the identifier being detected in a first frame and a third frame but not detected in a second frame, determining the candidate target based on an amount of change in an aspect ratio of the second bounding box and an amount of change in a height of the second bounding box in the third frame compared to the first frame,
wherein the first frame, the second frame, and the third frame exist in the consecutive frames, the first frame is before the second frame, and the third frame is between the first frame and the second frame.

9. The image capturing device of claim 2, wherein the determining of the ROI comprises determining the ROI comprising a motion detection box and a bounding box of the candidate target.

10. The image capturing device of claim 1, wherein the first learning model comprises an object recognition model, and the second learning model comprises a model for classifying poses of the person.

11. The image capturing device of claim 10, wherein the second learning model classifies the poses of the person into a standing pose, a bending pose, a sitting pose, and a lying pose.

12. The image capturing device of claim 11, wherein the processor is further configured to execute the instructions to perform determining, based on the poses of the person, whether the person having the identifier has fallen,
wherein the determining of whether the person having the identifier has fallen comprises determining that the person having the identifier has fallen based on the person corresponding to the candidate target and the pose of the person corresponding to the lying pose.

13. The image capturing device of claim 1, wherein the second learning model is created by generating a data set in which a plurality of images relating to poses of the person are respectively labelled with a standing pose, a bending pose, a sitting pose, and a lying pose.

14. A computer-readable recording medium on which a computer program is recorded, wherein the computer program comprises instructions that cause a processor to perform:
detecting a person having an identifier from consecutive frames using a first learning model;
determining a candidate target based on the person having the identifier and a candidate algorithm;
determining a region of interest (ROI) comprising the candidate target; and
estimating a pose of the person having the identifier in the ROI using a second learning model.

15. The computer-readable recording medium of claim 14, wherein the detecting of the person having the identifier comprises:
inputting the consecutive frames to the first learning model;
using the person as an object in the consecutive frames and obtaining a first bounding box corresponding to a head of the person and a second bounding box corresponding to an entire body of the person; and
determining, as the identifier, persons associated with each other based on the consecutive frames, the first bounding box, and the second bounding box.

16. The computer-readable recording medium of claim 15, wherein the determining of the candidate target comprises determining the candidate target based on an aspect ratio of the second bounding box, based on the person having the identifier being detected in a first frame and a second frame,
wherein the first frame and the second frame exist in the consecutive frames, and the first frame is before the second frame.

17. The computer-readable recording medium of claim 16, wherein the determining of the candidate target further comprises determining the person having the identifier as the candidate target based on the person having the identifier being detected in the first frame and the second frame and an amount of decrease in a height of the second bounding box in the second frame compared to the first frame being greater than or equal to a threshold.

18. The computer-readable recording medium of claim 16, wherein the determining of the candidate target further comprises determining the person having the identifier as the candidate target based on the person having the identifier being detected in the first frame and the second frame and an amount of change in a position of the first bounding box in the second frame compared to the first frame being greater than or equal to a threshold.

19. The computer-readable recording medium of claim 15, wherein the determining of the candidate target comprises, based on the person having the identifier being detected in a first frame and a third frame but not detected in a second frame, determining the candidate target based on an amount of change in an aspect ratio of the second bounding box and an amount of change in a height of the second bounding box in the third frame compared to the first frame,
wherein the first frame, the second frame, and the third frame exist in the consecutive frames, the first frame is before the second frame, and the third frame is between the first frame and the second frame.

20. The computer-readable recording medium of claim 14, wherein the second learning model is created by generating a data set in which a plurality of images relating to poses of the person are respectively labelled with a standing pose, a bending pose, a sitting pose, and a lying pose.
